(19) United States
(12) Patent Application Publication
(10) Pub. No.: US 2017/0193805 A1
(43) Pub. Date: Jul. 6, 2017

(54) REMOTE AUTHORIZATION AND CONTROL OF A NETWORKED DEVICE USING VISUAL INDICATION

(71) Applicants: Bradley Benjamin STAGG, Fort Mill, SC (US); Sara Cristina MELO, Charlotte, NC (US)

(72) Inventors: Bradley Benjamin STAGG, Fort Mill, SC (US); Sara Cristina MELO, Charlotte, NC (US)

(73) Assignee: White Stagg, LLC, Pineville, NC (US)

(21) Appl. No.: 15/400,286

(22) Filed: Jan. 6, 2017

Related U.S. Application Data
(60) Provisional application No. 62/275,279, filed on Jan. 6, 2016.

(51) Int. Cl. G08B 25/00; G08B 17/10

(52) U.S. Cl. CPC G08B 25/008; G08B 17/10

(57) ABSTRACT

The present invention provides methods and systems for an alarm system that an alarm device having a visual indicator, a wireless or wired connection; and a device having transmission capability and an application for allowing the device to communicate with the alarm device.

### FIELD OF THE INVENTION

The present invention relates generally to a system and method for silencing an alarm device by remote authorization and more generally relates to a device that allows the silencing of an alarm device by entering an indicator on a mobile device application or the like.

### BACKGROUND OF THE INVENTION

The current requirements for safety certification of smoke alarms require that a person be present in the physical proximity of the device in order to “hush” it or effectively identify that the current alert status seen by the device is in fact a non-emergency. The majority of devices in the field utilize a physical button on the device that requires a user to engage the device that is presenting an alert state, often requiring the user to utilize a step stool, ladder, or chair in order to reach the device when installed in the proper location (on or near the ceiling) or to use a tool of some sort (mop, broom, etc) to try to activate the “hush” button.

To further demonstrate the requirement of physical proximity required by the standard, current smoke alarms cannot be hushed by another device on the same network or in the same home, even if interconnected. In this regard, the position of the certifying body appears to be that line of sight to the specific area of concern is limited to room level rather than household level. Line of sight is considered a reasonable assumption of proximity previously by a certifying agency, and other product in the category has been able to use wireless signal strength or connectivity limitations to provide a similar confirmation of proximity.

### BRIEF SUMMARY OF THE INVENTION

According to an embodiment of the present invention, an alarm system that includes an alarm detector having an indicator, such as an audio or visual indicator, a wireless connection, such as a local area network transmitter and//or wireless local area network transmitter, and a mobile device having wireless transmitter/receiver capability and an application for allowing the mobile device to communicate with the alarm detector.

According to another embodiment of the present invention, the alarm system includes a smart phone as the mobile device, a tablet, PC, wall panel, display device, or the like.

According to yet another embodiment of the present invention, the alarm system includes a tablet as the mobile device.

According to yet another embodiment of the present invention, the alarm system includes a light ring as a visual indicator disposed on the alarm detector.

According to yet another embodiment of the present invention, the alarm system includes a screen as the visual indicator.

According to yet another embodiment of the present invention, the alarm system includes a smoke detector as the alarm detector.

According to yet another embodiment of the present invention, a method for remote authorization of a device using a visual indication that includes providing an alarm detector, a wireless local area network, and a mobile device having a wireless transmitter capability and an application for allowing the mobile device to communicate with the alarm detector.

According to yet another embodiment of the present invention, the method for remote authorization of a device using a visual indication that includes providing a smart phone as the mobile device.

According to yet another embodiment of the present invention, the method for remote authorization of a device using visual indication that includes providing a tablet as the mobile device.

According to yet another embodiment of the present invention, the method for remote authorization of a device using visual indication that includes providing a light ring as a visual indicator and disposed on the alarm detector.

According to yet another embodiment of the present invention, the method for remote authorization of a device using visual indication that includes providing a screen as the visual indicator.

According to yet another embodiment of the present invention, the method for remote authorization of a device using visual indication that includes providing a smoke detector as the alarm detector.

According to yet another embodiment of the present invention, an alarm system that includes an alarm device having a visual indicator, a device having transmission capability and an application for allowing the device to communicate with the alarm device, and a connection for allowing the alarm device and device to communicate.

According to yet another embodiment of the present invention, an alarm system that includes an alarm device having a visual indicator that is a light ring, a wireless connection, a mobile device having transmission capability and an application for allowing the device to communicate with the alarm device.

### BRIEF DESCRIPTION OF THE DRAWINGS

The present invention is illustrated and described herein with reference to the various drawings, in which like reference numbers denote like method steps and/or system components, respectively, and in which:

FIGS. 1a and 1b are a front view of the app displayed on a mobile device; and

FIG. 2 is a flow chart displaying the sequential steps of one embodiment of the present invention

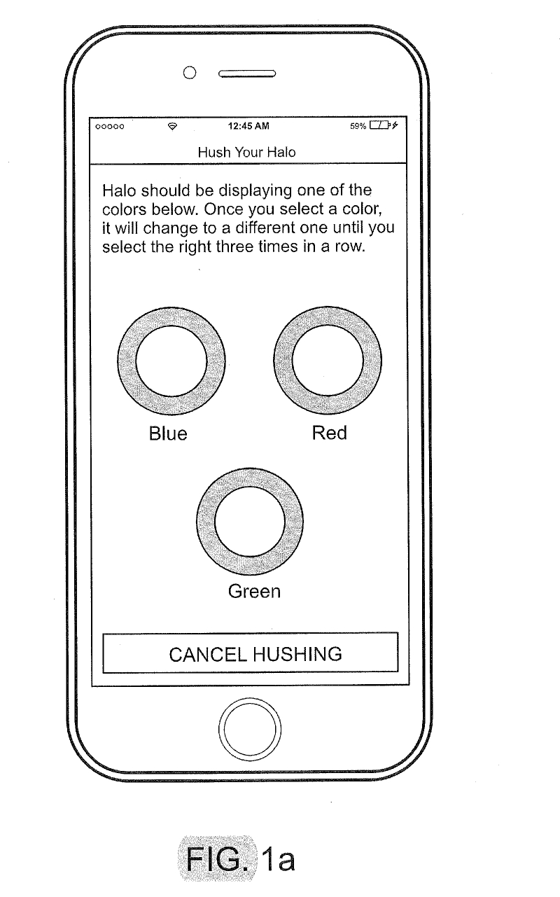

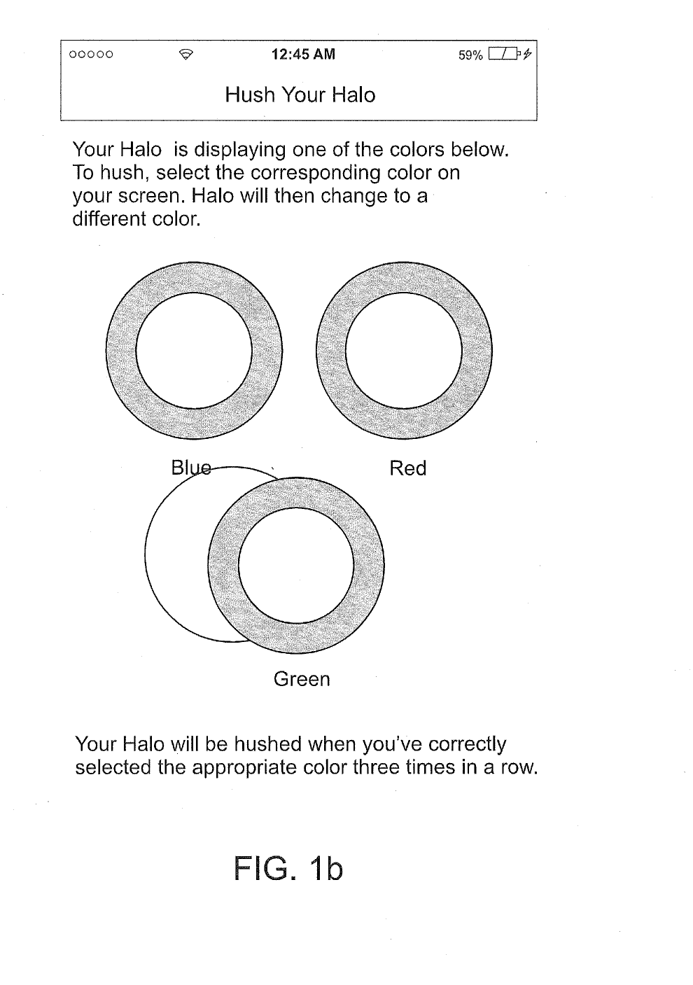

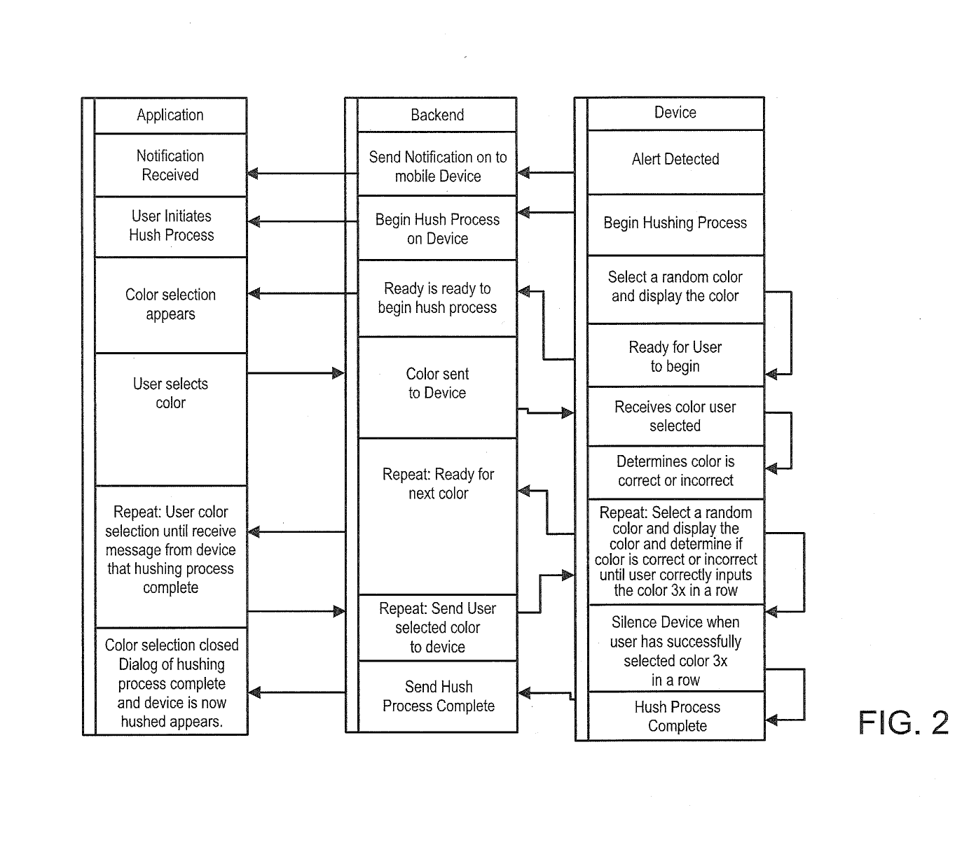

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

A system and method for the identification, verification, and authentication of an alarm device by a user on a mobile device application is described herein. The system and method allows a user to silence or “hush” an alarm device by mimicking or repeating an indicator produced by the alarm device using a mobile device, such as a smart phone or tablet. The alarm device is allowed to be silenced without the user having to physically touch the alarm device. By repeating the indicator, the user is confirming they have both a line of sight and proximity to the alarm device, for safely silencing the alarm device without having to physically interact with the device. The system and method described herein increases convenience and reduces the potential for injury by falling or damage to a device commonly used to physically interact with the alarm device, such as a broom, mop, etc.

In its simplest form, the alarm device of the invention comprises a detection unit, e.g. an alarm device, a wireless transmitter/receiver associated with the detection unit, and a transmission device. The wireless transmitter/receiver is preferably a wireless local area network (WLAN) device operating under a suitable wireless standard such as IEEE 802.11, and can be implemented by any of many commonly available wireless gateway or router devices. The wireless transmitter/receiver may also be a cellular transmission. Almost any such device will have a sufficient range to communicate with a transmitter in a single detached dwelling. In larger buildings, higher power transmitters, special antennas, repeaters, boosters, or redundant transmitter units, can be utilized to ensure reliable coverage.

The transmission device can be a smart phone, a tablet, PC, wall panel, or other display device. Examples of a wall panel may be a screen or visual device engaged to a wall, such as a security alarm panel engaged to a wall. The display device may be a wireless screen that is movable and can possess transmission capabilities. The transmission device can have the capability of transmitting locally generated wireless signals to the receiver of the alarm device by way of a wireless connection, such as LAN, WLAN or cellular signal. It should be noted that a transmission device may also be a dedicated transmission unit that can communication with the receiver of the alarm device. The transmission device may also be hard wired and transmit a signal through a wire.

The alarm device may contain a display panel for providing an indicator to the user. The display panel may consist of a screen, such as an LCD screen for providing the indicator. Alternatively, the display panel may consist of variously colored modules or a lighting ring that illuminates to provide an indicator. The indicator may be a random selection of a color pattern (e.g. red, blue, green), a pattern (e.g. 1 blink, 2 blinks, 3 blinks), or a display of a number or numbers on the screen.

The alarm device may be a smoke detector, such as those based upon either an ionization or photoelectric detection. In ionization detection, the detecting part has, for example, an inner electrode having a radiation source, an intermediate electrode set so as to face the inner electrode, and an outer electrode (outer chamber) formed so as to cover the opposite side to the inner electrode of the intermediate electrode, in which the gap between the inner electrode and the intermediate electrode is formed as an almost-closed inner ionization chamber and the gap between the intermediate electrode and the outer chamber is formed as an outer ionization chamber allowing smoke to enter from the outside.

An opening is formed on the intermediate electrode so that the radiation emitted from the radiation source provided for the inner electrode can be also irradiated to the outer ionization chamber. The ionization smoke detector uses a field effect transistor (hereafter referred to as FET) for detecting a potential change at the joint between the inner and outer ionization chambers and the intermediate electrode is connected to the FET. Because an ionization smoke detector has a relatively complicated structure having an inner ionization chamber and an outer ionization chamber as described above, the detector has problems that it takes a lot of time to assemble and set the detector and it is difficult to decrease the cost.

For example, in the case of the FET, the insulation between terminals may be deteriorated due to humidity or dust. Therefore, it is preferable to use the FET in a closed state. Moreover, it is necessary that an intermediate electrode connected to the FET is set so as to face an inner electrode under an insulated state. Therefore, it is troublesome to set the FET and intermediate electrode.

Photoelectric detection includes a detector for detecting an infrared (IR) light source and an IR photodiode receiver positioned at opposite ends of a detection chamber. They are located off axis from each other to prevent the IR light source emitted energy from flowing directly to the receiver. Light absorbing baffles and coatings within the chamber are used to attenuate all quiescent state IR reflections, to provide a controlled, minimum value of photodiode current in the non-smoke state. In the event of a fire, combustion particles entering the detector's chamber disturb the quiescent state absorption characteristics, thereby producing IR scattering and causing IR energy to be detected by the photodiode. The photodiode responds by providing an output electrical current at a magnitude proportional to the detected IR, and when the current exceeds a selected threshold the detector sounds the alarm. Existing types of carbon monoxide detectors can be broadly classified into one of four types according to the gas sensitive element employed: chemical, electrochemical, semiconducting or spectroscopic (infrared). The electrochemical and spectroscopic devices, whilst offering rapid response times, high resolution and high accuracy, are expensive and not suitable for domestic use. Chemical sensors are inexpensive devices that are usually based on palladium or iodine salts which exhibit a color change upon exposure to CO. They are of two classes; tapes for continuous monitoring which can provide very fast and sensitive response (typically sub ppm concentrations are sensed) but these require very careful control over moisture content and tubes which are used for spot checks and are of generally lower sensitivity than tapes although they do not require such careful control of moisture. Both types rely on a color change and could not be made “automatic” by the application of an electronic device the degree of color change. These devices are not reusable. However, their response to low CO concentrations tends to be poor and therefore constant monitoring is required and can only be used once and fail to provide audible warning signals.

Although a smoke detector has been described herein, the alarm device may be a physical sensor, environmental sensor, monitored sensor, or connected sensor. By way of example only and not meant to be limiting, the sensor may include a carbon monoxide detector, leak sensor, water sensor, gas sensor, proximity sensor, motion sensor or any other networked device that would been to be tested and the user have a visual line of sight.

The alarm device is configured to receive a signal from a user on a mobile device, PC, wall panel or other display device. An app on the mobile device is downloaded by the user, wherein the app transmits information to the receiver of the alarm device. The app allows the user to input a repeat of the indicator provided by the alarm device. The app then transmits what is input by the user to a receiver on the alarm device, where the transmission is verified for accuracy.

During use, the alarm device is activated and transmits an audio signal from a speaker contained within the alarm device for testing the alarm device to ensure it is in good, proper, working order. An indicator is provided by the alarm device. In one example, a lighting ring on the alarm device will indicate a specific color pattern, such as red, blue, green. The user opens an application on their mobile device and repeats the color pattern on the application. The color pattern entered on the application of the mobile device is then transmitted to the receiver of the alarm device by way of the transmission device. If the user correctly enters the color pattern, the alarm device is silenced. In an alternative embodiment, the pattern would need to be entered three (3) times correctly in order to hush or silence the alarm device. In this embodiment, the alarm device will not repeat the color more than two (2) times. The alarm device will also include a manual button for hushing or silencing the device.

In another alternative embodiment, the app may provide a second level of verification that the user is in the line of sight of the alarm device. Although most mobile devices have a global positioning system (GPS) receiver capable of locating a mobile device with relatively high accuracy, GPS receivers do not work well inside buildings because the building structures shield the signals transmitted by overhead positioning satellites. However, mobile devices having GPS capability can be located indoors by the use of “pseudo satellite” transmitting units as described in U.S. Patent Application Publication 2013/0093619, published Apr. 18, 2013. Mobile devices can also be located indoors by calculations based on signal strength measurements as described in U.S. Patent Application Publication 2012/0322501, published Dec. 20, 2012, and by sensing vibrations acoustically using microphone arrays as described in U.S. Patent Application Publication 2013/0053053, published Feb. 28, 2013. The disclosures of these three U.S. Patent Application. Publications are incorporated by reference. Any one of these systems can be utilized to locate the user's smart phone, and thereby locate the user with good accuracy indoors. The information concerning the user's location will ensure the user is in the line of sight of the alarm device.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. An alarm system, comprising:
an alarm device having a visual indicator;
a device having transmission capability and an application for allowing the device to communicate with the alarm device; and
a connection for allowing the alarm device and device to communicate.

2. The alarm system according to claim 1, wherein the mobile device is a smart phone.

3. The alarm system according to claim 1, wherein the mobile device is a tablet.

4. The alarm system according to claim 1, wherein the visual indictor is a light ring.

5. The alarm system according to claim 1, wherein the visual indicator is a screen.

6. The alarm system according to claim 1, wherein the alarm detector is a smoke detector.

7. A method for remote authorization of a device using a visual indication, comprising:
providing an alarm device, a wireless or wired connection, and a device having transmission capability and an application for allowing the device to communicate with the alarm device.

8. The method for remote authorization of a device using a visual indication according to claim 7, wherein the mobile device is a smart phone.

9. The method for remote authorization of a device using a visual indication according to claim 7, wherein the mobile device is a tablet.

10. The method for remote authorization of a device using a visual indication according to claim 7, wherein the visual indictor is a light ring disposed on the alarm detector.

11. The method for remote authorization of a device using a visual indication according to claim 7, wherein the visual indicator is a screen.

12. The method for remote authorization of a device using a visual indication according to claim 7, wherein the alarm detector is a smoke detector.

13. An alarm system, comprising:
an alarm device having a visual indicator that is a light ring;
a wireless connection; and
a mobile device having transmission capability and an application for allowing the device to communicate with the alarm device.

14. The alarm system according to claim 13, wherein the mobile device is a smart phone.

15. The alarm system according to claim 13, wherein the mobile device is a tablet.

16. The alarm system according to claim 13, wherein the visual indictor is a light ring.

17. The alarm system according to claim 13, wherein the visual indicator is a screen.

18. The alarm system according to claim 13, wherein the alarm detector is a smoke detector.
